(19) United States
(12) Patent Application Publication
(10) Pub. No.: US 2014/0243252 A1
(43) Pub. Date: Aug. 28, 2014

(54) LAUNDRY DETERGENT FORMULATION

(71) Applicant: FutureFuel Chemical Company, Clayton, MO (US)

(72) Inventors: Dimmick L. Bymaster, Batesville, AR (US); Tom Tackett, Pleasant Plains, AR (US)

(73) Assignee: FutureFuel Chemical Company, Clayton, MO (US)

(21) Appl. No.: 14/191,630

(22) Filed: Feb. 27, 2014

Related U.S. Application Data
(60) Provisional application No. 61/770,453, filed on Feb. 28, 2013.

(51) Int. Cl. C11D 3/395

(52) U.S. Cl. CPC C11D 3/3951
USPC 510/302; 510/367; 252/186.1

(57) ABSTRACT

An improved binder for use in making laundry detergent compositions, more specifically bleach activator granules, is described. The binder utilizes glycerin as a replacement for fatty acids in the overall granule mixture which improves solubility and reduces odor.

### RELATED APPLICATION

This application claims priority to U.S. Provisional Application Ser. No. 61/770,453 filed on 28 Feb. 2013, the entire content of which is hereby incorporated by reference in its entirety

### BACKGROUND OF THE INVENTION

The present invention relates generally to a mixed powder or a mixed granule based on detergents that utilize oxybenzene sulfonates as active ingredients. More specifically, the invention relates to detergent formulations that incorporate salts of oxybenzene sulfonates, and particularly salts of nonanoly oxybenzene sulfonate commonly known as NOBS.

Granulated detergents and cleaners and processes for making them are known in the art. Two of the major components in granulated detergents and cleaners, particularly laundry detergents, are bleach activators and “percompounds”. A “percompound” is a chemical compound, typically an inorganic peroxide compound, which releases hydrogen peroxide by dissolving in water (e.g., sodium perborate and sodium percarbonate perhydrate). Such compounds are used as oxidants for disinfecting and bleaching. However, the oxidation properties of such compounds are temperature dependent. For example, hydrogen peroxide or perborate in alkaline bleaching solutions exhibit acceptable bleaching performance on soiled textiles only at temperatures above 80° C. Heating water to at least 80° C. requires significant energy which increases costs and decreases efficiencies.

Bleach activators were developed to increase the effectiveness of hydrogen peroxide based detergents at lower temperatures. Bleach activators are “peracid” precursors in that they react with hydrogen peroxide in aqueous solutions to form peracids. Peracids are more kinetically powerful bleaching agents than hydrogen peroxide. This characteristic generally allows improved cleaning and bleaching performance under more benign conditions, such as reduced temperatures.

Bleach activators typically are described as being of one of three types. There are neutral bleach activators (e.g. N,N,N′,N′-tetra acetyl ethylene diamine, TAED); anionic bleach activators anionic (e.g. nonanoyl benzene sulfonic acid, sodium salt; NOBS); and cationic bleach activators N-[4-(triethylammoniomethyl) benzoyl] butyrolactamchloride, TBBC).

Although the chemistry underling bleach activators and laundry detergents is somewhat mature, the laundry detergent market remains highly competitive as evidenced by the large number of choices exhibited on any laundry detergent aisle in any major retailer. Manufacturers continually try to reduce costs and improve the performance of their products to lure new customers.

Solubility and odor are two areas where there is a need for improved detergent compositions. As seen in the art, solubility of detergents is important because poor solubility leads to wasted product, poor performance, and poor consumer experience leading to lost sales. One potential cause of solubility problems are the fatty acids that are commonly used in the binder formulations that hold bleach activator granules together. Nonanoic acid (a C9 fatty acid) and C16 fatty acids are commonly used in binder formulations. They typically serve as both a lubricant during high temperature extrusion processes and as a physical binder at ambient temperatures.

Some detergent compositions often have an inherent unpleasant odor which leads to poor consumer experience. The same fatty acids that hinder solubility, particularly nonanoic acid, also contribute to the odor problem. To compensate for odor many manufacturers add perfumes or other masking agents to detergent compositions which increases costs.

Thus there is a continuing need for new formulations that improve the performance of detergents, particularly increasing solubility and decreasing odor, and/or provide other benefits that are recognizable to consumers. Such formulations would reduce or potentially eliminate the use of fatty acids as a binder component yet still form commercially acceptable bleach activator granules. The claimed invention is such a formulation.

### SUMMARY OF THE INVENTION

In one aspect, the invention encompasses a process for the preparation of bleach activator granules. The process comprises the step of extruding a mixture comprising a bleach activator and a binder where the binder comprises an anionic or nonionic surfactant, a polyglycol and glycerin.

In another aspect, the invention encompasses a process for the preparation of bleach activator granules. The process comprises the steps of extruding a mixture comprising a bleach activator and a binder where the binder consists essentially of an anionic or nonionic surfactant, a polyglycol and glycerin.

In another aspect, the invention encompasses a process for the preparation of bleach activator granules where the process comprises the step of extruding a mixture comprising a bleach activator and a binder where the binder comprises an anionic or nonionic surfactant, a polyglycol, glycerin, and a fatty acid.

In another aspect, the invention encompasses a process for the preparation of bleach activator granules where the process comprises the step of extruding a mixture comprising a bleach activator and a binder where the binder consists essentially of an anionic or nonionic surfactant, a polyglycol, glycerin, and a fatty acid.

In a still further aspect, the invention encompasses a laundry detergent composition comprising a bleach activator and a binder where the binder comprises an anionic or nonionic surfactant, a polygycol and glycerin. A fatty acid can be added to the binder as well.

In yet another aspect, the invention encompasses a laundry detergent composition comprising a bleach activator and a binder where the binder consists essentially of an anionic or nonionic surfactant, a polygycol and glycerin. A fatty acid can be added to the binder as well.

### DETAILED DESCRIPTION OF THE INVENTION

In the following description, for purposes of explanation, numerous details are set forth to provide an understanding of one or more embodiments of the present invention. Furthermore, the following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description.

While the invention is described with respect to various embodiments thereof, it will be understood by those skilled in the art that various changes in detail may be made therein without departing from the spirit, scope, and teaching of the invention. Accordingly, the invention herein disclosed is limited only as specified in the claims.

“Cleaning” means to perform or aid in soil removal, bleaching, microbial population reduction, rinsing, or combination thereof.

As used herein, weight percent (wt-%), percent by weight, % by weight, and the like are synonyms that refer to the concentration of a substance as the weight of that substance divided by the total weight of the composition and multiplied by 100.

As used herein, the term “about”, when modifying the quantity of an ingredient in the compositions of the invention or employed in the methods of the invention, refers to variation in the numerical quantity that can occur, for example, through typical measuring and liquid handling procedures used for making concentrates or solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

It should be noted that, as used in this specification and the appended claims, the singular forms “a,” “an,” and “the” include plural references unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

As used herein, the term “substantially free” refers to compositions completely lacking the component or having such a small amount of the component that the component does not affect the effectiveness of the composition. The component may be present as an impurity or as a contaminant and shall be less than 0.5 wt %. In another aspect, the amount of the component is less than 0.1 wt-% and in yet another aspect, the amount of component is less than 0.01 wt %.

As used herein, the phrase “consisting essentially of” refers to a composition including the listed ingredients and/or amounts of listed ingredients and does not include additional ingredients affecting the composition's ability to clean or dissolve or that would impart undesirable odors.

The technology of the present invention can be applied to many different bleach activators including neutral bleach activators (e.g. N,N,N′,N′-tetra acetyl ethylene diamine, TAED); anionic bleach activators anionic (e.g. nonanoyl benzene sulfonic acid, sodium salt; NOBS); and cationic bleach activators N-[4-(triethylammoniomethyl) benzoyl] butyrolactamchloride, TBBC).

Examples of suitable bleach activators are N,N,N′,N′-tetraacetylethylendiamine (TAED), glucose pentaacetate (GPA), xylose tetraacetate (TAX), sodium 4-benzoyloxybenzenesulfonate (SBOBS), sodium trimethylhexanoyloxybenzenesulfonate (STHOBS), tetraacetylglycoluril (TAGU), tetraacetylcyanic acid (TACA), di-N-acetyldimethylglyoxime (ADMG), 1-phenyl-3-acetylhydantoin (PAH), nonanoylcaprolactam phenylsulfonate ester (APES), nitrilotriacetate (NTA), the sodium salt of nonanoyloxybenzenesulphonic acid (NOBS), the sodium salt of 3,5,5-trimethylhexanoyloxyphenylsulfonic acid (iso-NOBS), the sodium salt of acetoxyphenylsulfonate, sodium decanoyloxybenzene sulfonic acid (DOBS), and sodium octanoyloxybenzene sulfonic acid (OOBS). NOBS is a preferred bleach activator.

The technology of the present invention is particularly well suited for bleach activators that are commonly formulated with binder mixtures such as tetraacetylethylene diamine (TAED), sodium nonanoyloxybenzenesulfonic acid (NOBS), iso-NOBS, sodium decanoyloxybenzoic acid (DOBA), sodium lauroyloxybenzene sulfonate (LOBS), sodium nonanoyloxybenzoic acid (NOBA), sodium decanoyloxybenzene sulfonic acid (DOBS), and sodium octanoyloxybenzene sulfonic acid (OOBS). For ease of discussion the detailed description focuses on detergent formulations based on NOBS. This narrative convenience should not be interpreted as limiting the scope of the invention.

The manufacturing methods for the above mentioned bleach activator compounds are known in the art. The manufacture of NOBS is described in many documents including U.S. Pat. No. 4,619,779 to Hardy, which is incorporated by reference in its entirety. Those skilled in the art are familiar with the production of NOBS therefore it is not discussed herein in detail.

The present invention relates to an improved binder system for the preparation of pelletized or granular bleach activators (collectively, “granules”). As described in WO 99/27061, bleach activators are often formulated in the form of cylindrical extrudates to ensure compatibility with other laundry detergent constituents and provide adequate storage stability. This detailed description utilizes extrusion technology but this narrative convenience should not be interpreted as limiting the scope of the invention since other particle making technologies are known in the art.

To avoid separation of the various particles in the laundry detergent formulation during transportation and storage, the particle diameter should be between 0.2 mm and 3 mm, preferably between 0.5 mm and 1.0 mm, and the particle length should be in the range from 0.2 mm to 3.5 mm, ideally between 0.5 mm and 2.5 mm. Particles having a near spherical shape are particularly preferred. Accordingly, if the particle is made using an extrusion process, particles having a length to diameter ratio around one (1) are preferred.

In one broad aspect, the invention encompasses a process for the preparation of bleach activator granules where the process comprises the step of extruding a mixture comprising a bleach activator and a binder. The binder utilized in the process comprises an anionic or nonionic surfactant, a polyglycol and glycerin. In an alternative aspect, the binder utilized in the process consists essentially of an anionic or nonionic surfactant, a polyglycol and glycerin.

Alternatively, the process can be described as a process for preparing bleach activator granules wherein the process comprises extruding a mixture comprising a bleach activator, a polyglycol, an anionic or nonionic surfactant and glycerin at elevated temperatures. In a further alternative, this process can be described as a process for preparing bleach activator granules wherein the process consists essentially of extruding a mixture comprising a bleach activator, a polyglycol, an anionic or nonionic surfactant and glycerin at elevated temperatures.

In yet another alternative, the process can be described as a process for the preparation of bleach activator granules where the process comprises the step of extruding a mixture comprising a bleach activator and a binder wherein the binder comprises an anionic or nonionic surfactant, a polyglycol and glycerin, and wherein the binder does not contain a fatty acid.

In yet another alternative, the process can be described as a process for the preparation of bleach activator granules where the process comprises the step of extruding a mixture comprising a bleach activator and a binder wherein the binder consists essentially of anionic or nonionic surfactant, a polyglycol and glycerin, and wherein the binder does not contain a fatty acid.

In a still further alternative, the process according to the invention can be described as a process for the preparation of bleach activator granules wherein the process comprises the step of extruding a mixture comprising a bleach activator and a binder wherein the binder comprises an anionic or nonionic surfactant, a polyglycol, glycerin, and a fatty acid.

In a still further alternative, the process according to the invention can be described as a process for the preparation of bleach activator granules wherein the process comprises the step of extruding a mixture comprising a bleach activator and a binder wherein the binder consists essentially of an anionic or nonionic surfactant, a polyglycol, glycerin, and a fatty acid.

In a still further alternative, the process according to the invention can be described as a process for the preparation of bleach activator granules wherein the process comprises the step of extruding a mixture comprising a bleach activator, an anionic or nonionic surfactant, a polyglycol, and glycerin. A fatty acid can be added to the mixture if desired. Alternatively, the mixture can consist essentially of a bleach activator, an anionic or nonionic surfactant, a polyglycol, and glycerin or consist essentially of a bleach activator, an anionic or nonionic surfactant, a polyglycol, glycerin, and a fatty acid.

In all of the various aspects of the process according to the invention, the extrusion product is collected and formed into granules using standard granulating techniques.

Turning now to more specific aspects of the invention, the present invention provides a process for manufacturing a variety of granulated laundry detergent additives, specifically bleach activator granules. An exemplary method according to the invention uses high shear mixing of a bleach activator and a binder material followed by extrusion and granulization/pelletation. As noted previously, extrusion is one method of forming granules and the scope of the invention is not limited to just extrusion processes.

The process begins by forming a mixture of binder and bleach activator. In a basic aspect the mixture comprises the following components (expressed as total weight percent of the entire mixture): bleach activator (50%-95%), a polyglycol (1.0%-23.0%), anionic or nonionic surfactant (0.1%-18.0%), and glycerin (0.5%-19.0%). If the mixture also includes a fatty acid, as mentioned previously, it is present in an amount (weight percent) from just above 0% (e.g., 0.01%) to 8.0%. To the extent a fatty acid is used in any form of the invention, C16 fatty acids are preferred.

In a more preferred aspect the mixture comprises the following components (expressed as total weight percent of the entire mixture): bleach activator (75%-92%), a polyglycol (4.0%-15%), anionic or nonionic surfactant (1%-10.0%), and glycerin (1%-10.0%). If this aspect of the mixture also includes a fatty acid, as mentioned previously, it is present in an amount (weight percent) between 0.01% and 6.5%. As mentioned previously, the quantities of fatty acids utilized in the practice of the invention should be minimized to the extent possible.

More preferred compositions include: bleach activator (84%-89%), polyglycol (4.4%-7.7%), anionic or nonionic surfactant (1.5%-3.5%), and glycerin (1%-6.0%). If the mixture also contains a fatty acid, the more preferred weight percentage for fatty acid is 0.01%-6.0%.

Particularly preferred compositions include: bleach activator (84.5%-87.2%), polyglycol (5.0%-6.3%), anionic or nonionic surfactant (1.75%-3.0%), and glycerin (1.5%-5.3%). If the mixture also contains a fatty acid, the more particularly preferred weight percentage is fatty acid (0.01%-5.5%).

The preceding paragraphs set forth several variations of mixtures and weight percent ranges for the various components which comprise the mixture. Those variations and weight percent ranges are equally applicable to mixtures which consist essentially of the above described components.

The above described mixture of all components can additionally comprise or consist essentially of small amounts of a solvent, preferably less than 15% by weight, preferably less than 10% by weight, particularly preferably less than 7% by weight. A preferred solvent is water. However, in preferred mixtures, water is not a separate added component of the mixture and to the extent it is present, it is present as a carried contaminant of the other components.

Preferred anionic surfactants are alkali metal salts, ammonium salts, amine salts and salts of amino alcohols from the following compounds: alkyl sulfates, alkyl ether sulfates, alkylamide sulfates and alkylamide ether sulfates, alkylaryl polyether sulfates, monoglyceride sulfates, alkylsulfonates, alkylamidosulfonates, alkylarylsulfonates, alpha-olefinsulfonates, alkylsulfosuccinates, alkyl ether sulfosuccinates, alkylamide sulfosuccinates, alkyl sulfoacetates, alkylpolyglyceryl carboxylates, alkyl phosphates, alkyl ether phosphates, alkyl sarcosinates, alkyl polypeptidates, alkyl amidopolypeptidates, alkyl isothionates, alkyl taurates, alkyl polyglycol ether carboxylic acids, or fatty acids, such as oleic acid, ricinoleic acid, palmitic acid, stearic acid, copra oil acid salt or hydrogenated copra oil acid salts. The alkyl radical in all of these compounds normally contains 8-32, preferably 8-22 carbon atoms. Particular preference is given to linear straight-chain alkylbenzenesulfonates, in particular with a C8-C20, particularly preferably with a C11-C13 alkyl group. Sodium C10-C16 alkylbenzensulfonate (LAS) is a preferred surfactant.

Preferred nonionic surfactants are polyethoxylated, polypropoxylated or polyglycerolated ethers of fatty alcohols, polyethoxylated, polypropoxylated and polyglycerolated fatty acid esters, polyethoxylated esters of fatty acids and of sorbitol, polyethoxylated or polyglycerolated fatty amides.

Suitable polyalkylene glycols are polyethylene glycols, 1,2-polypropylene glycols, and modified polyethylene glycols and polypropylene glycols. The modified polyalkylene glycols include, in particular, sulfates and/or disulfates of polyethylene glycols or polypropylene glycols with a relative molecular mass between 600 and 12,000, and in particular between 1000 and 4000. A further group consists of mono- and/or disuccinates of the polyalkylene glycols, which again have relative molecular masses between 600 and 6000, preferably between 1000 and 4000. In addition, ethoxylated derivatives such as trimethylolpropane are also included.

The preferred polyethylene glycols used may have a linear or branched structure, preference being given in particular to linear polyethylene glycols. Particularly preferred polyethylene glycols include those with relative molecular masses between 2000 and 12000, advantageously around 4000, where polyethylene glycols with relative molecular masses below 3500 and above 5000 can in particular be used in combination with polyethylene glycols with relative molecular mass around 4000, and such combinations advantageously have more than 50% by weight, based on the total amount of the polyethylene glycols, of polyethylene glycols with a relative molecular mass between 3500 and 5000.

The modified polyethylene glycols also include polyethylene glycols and derivatives which are terminally capped on one or more sides. When such glycols are used the end-groups are preferably C1-C12-alkyl chains, preferably C1-C6, which may be linear or branched.

To improve the plasticizing and lubricant properties, but also the abrasion resistance of the bleach activator granules, some formulations add one or more components which are liquid at room temperature or are in the form of a melt under the processing conditions, for example linear or branched fatty acids, in particular a C16 fatty acid, and/or ethoxylated fatty acids. However, as mentioned previously, adding fatty acids can decrease solubility and increase odor. Yet, removing them tends to increase the pressures required for extrusion which in turn drives up production costs. Thus, in preferred aspects of the process according to the invention glycerin is substituted for fatty acids in the binder mixture.

Further suitable additives are substances which influence the pH during storage and use. These include organic carboxylic acids or salts thereof, such as citric acid in anhydrous or hydrated form, glycolic acid, succinic acid, maleic acid or lactic acid. Also possible are additives which influence the bleaching power, such as complexing agents and transition metal complexes, e.g. iron-, cobalt- or manganese-containing metal complexes, as described in EP-A-0 458 397 and EP-A-0 458 398.

The manner of forming the mixture can vary depending upon the production process. In most instances it is envisioned that the components are mixed in a high shear mixing device such as a Turbulizer® from Bepex International LLC. In preferred aspects the only component that is typically liquid at room temperature liquid is glycerin. Therefore, the mixing step is usually conducted in the presence of applied heat. The amount of heat applied during mixing is that which is necessary to achieve a homogenous mixture suitable for extrusion. A complete melt of all components may or may not be necessary depending on the precise combination of components utilized. Care should be taken not to apply excessive heat which could cause reactions between the components or otherwise adversely affect the characteristics and performance of the components and final product.

The heat applied at the mixing step will vary with production conditions, ambient conditions and the composition of the mixture. Those skilled in the art are capable of choosing the mixing conditions that are appropriate for their process. If NOBS is the bleach activator, mixing temperatures should be between about 20° C. and 80° C.

Table 1 contains representative formulas for mixtures containing NOBS as the bleach activator. These mixtures were mixed in a Bepex Turbulizer® using a jacket temperature of 22° C.-25° C. (73° F.-77° F.). The product mixture temperature leaving the Turbulizer® was between 40° C.-65° C. (104° F.-148° F.).

After mixing, the mixture is compressed into extrudates. In preferred aspects the resulting particle diameter should be between 0.2 mm and 3 mm, preferably between 0.5 mm and 1.0 mm, and the particle length should be in the range from 0.2 mm to 3.5 mm, ideally between 0.5 mm and 2.5 mm.

The temperature and pressure ranges for the extrusion process will vary depending on equipment and mixture components. Generally speaking, there is an inverse relationship between the weight percents of surfactant and fatty acids in the mixture and the pressure/screw speed used in the extrusion process. More surfactants translate to lower extrusion pressures/screw speed.

The relationship between extrusion temperature and surfactant and/or fatty acid weight percent is also inverse. Generally speaking, greater amounts of surfactants and/or fatty acids translate to lower extrusion temperatures.

Those skilled in the art are capable of adjusting processing conditions to meet their particular needs. However, it should be noted that adjusting processing conditions to meet particular needs is not just a matter of optimizing a production process. There are boundaries on either end of the processing spectrum that define commercially acceptable product and processes. If extrusion pressures and temperatures are too high the equipment and energy costs prevent commercial viability. Too much surfactant or other lubricants may render the product unstable.

In most extrusion processes an extrusion temperature in the range from about 30° C. to 140° C. should suffice Extrusion pressures can vary considerably based upon mixture composition, temperatures, and die diameters. Some screw-based extruders utilize screw speed as a defining parameter instead of or in addition to pressure. Those skilled in the art are capable of selecting the pressures and screw speed that work best with their operating parameters.

The examples provided herein define processing conditions based on temperature, screw speed and power levels of laboratory equipment.

In a preferred aspect of the invention, the mixture is introduced into a single-shaft extruder, twin-shaft extruder or twin-screw extruder with co-current or countercurrent screw control, the housing of which and the extruder granulator head of which can be heated to the predetermined extrusion temperature. Under the shear action of the extruder screws, the mixture is compressed, plasticized, and extruded in the form of extrudates through the perforated die plate in the extruder head. Where necessary, the extrudate is powdered with fine particulate anticaking agent, for example TiO₂, silica, zeolite, or its own dust.

The mixtures utilized in the examples were extruded through an Extrud-O-Mix (EM-6-K5F424) extruder with 0.9 mm holes in the die plate at 41-125° C. (106-257° F.). The extrusion operating conditions are shown in Table 3.

Following extrusion, the extrudate is cut into appropriately sized particles or is otherwise mechanically altered to achieve the desired particle dimensions. The resulting product is then cooled and packaged. Such mechanical manipulations are known in the art and need not be discussed in detail herein.

The invention also encompasses a laundry detergent composition produced in accordance with the above described processes. In very broad terms, the laundry detergent composition comprises a bleach activator selected from those previously discussed and a binder where the binder comprises an anionic or nonionic surfactant, a polyglycol and glycerin. The weight percentages for these components recited in the description of the process according to the invention apply here as well. Additionally, the binder may or may not comprise a fatty acid, particularly a C16 fatty acid, in the same weight percentage as discussed with respect to the process according to the invention. In preferred aspects of the laundry detergent composition, the binder and overall mixture does not contain a fatty acid.

Alternatively, the laundry detergent composition according to the invention consists essentially of a bleach activator selected from those previously discussed and a binder where the binder consists essentially of an anionic or nonionic surfactant, a polyglycol and glycerin. The weight percentages for these components recited in the description of the process according to the invention apply here as well. Additionally, the binder may or may not consist essentially of a fatty acid, particularly a C16 fatty acid, in the same weight percentage as discussed with respect to the process according to the invention. In preferred aspects of the laundry detergent composition, the binder and overall mixture does not contain a fatty acid.

In preferred mixtures, the bleach activator is selected from the group consisting of TAED, NOBS, iso-NOBS, DOBA, LOBS, DOBS, GOBS, and NOBA, with NOBS being particularly preferred.

The above described mixture of composition components can additionally comprise or consist essentially of small amounts of a solvent, preferably less than 15% by weight, preferably less than 10% by weight, particularly preferably less than 7% by weight. A preferred solvent is water. However, in preferred mixtures, water is not a separate added component of the mixture and to the extent it is present, it is present as a carried contaminant of the other components.

### EXAMPLES

Mixtures of binder and bleach activator were prepared. Those mixtures are shown in Table 1. The control mixture (Blend A) represents a commercially available granulated bleach activator.

TABLE 1

| | Blend # | | | | |
|---|---|---|---|---|---|
| | A | | | | |
| | Control | B | C | D | E |
| NOBS powder | 84.8 | 84.8 | 86.9 | 89.0 | 87.0 |
| PEG 4000 | 5.2 | 5.2 | 6.1 | 4.4 | 5.2 |
| LAS | 2.7 | 2.7 | 2.0 | 0.0 | 0.0 |
| C9FA | 2.1 | 0.0 | 0.0 | 0.0 | 2.6 |
| C16FA | 5.2 | 5.2 | 0.0 | 4.4 | 5.2 |
| Glycerin | 0.0 | 2.1 | 5.0 | 2.2 | 0.0 |

All numbers are in weight percent.
PEG 4000 = polyethylene glycol 4000
LAS = Sodium C10-C16 alkylbenzensulfonate
C9FA = C9 fatty acid, also known as nonanoic acid
C16FA = C16 fatty acid

The mixtures of Table 1 were fed to a high shear mixer. In these examples a Turbulizer® (TCJS-8) with a jacket temperature of 20-25° C. (73-77° F.) and product mix temperature of 40-65° C. (104-148° F.) was utilized. The mixing conditions are shown in Table 2.

TABLE 2

| | Blend # | | | | |
|---|---|---|---|---|---|
| | A | | | | |
| | Control | B | C | D | E |
| Turbulizer | | | | | |
| (TCJS-8) | | | | | |
| Load, amps | 6.5-11.6 | 7.2-8.7 | 6.1-6.2 | 6.1-6.1 | 7.0-7.3 |
| Load amps (est. | 8.9 | 8.4 | 6.2 | 6.1 | 7.2 |
| representative | | | | | |
| value during | | | | | |
| run) | | | | | |
| No Load, amps | 6.0 | 6.0 | 6.0 | 6.0 | 6.0 |
| Speed, rpm | 1100 | 1100 | 1100 | 1100 | 1100 |
| Solid Feed Rate, | 200 | 200 | 200 | 200 | 200 |
| lb/hr | | | | | |
| Liquid Feed | 37.3 | 37.5 | 30.3 | 24.7 | 29.9 |
| Rate, lb/hr | | | | | |
| Measured Ave | 36.8 | 36.1 | 30.0 | 26.2 | 29.9 |
| Feed, lb/hr | | | | | |
| Liquid Feed | * | * | * | * | 218-229 |
| Tank | | | | | |
| Temp, F. | | | | | |
| Ambient, F | 69 | 71 | 70 | 72 | 70 |
| Turb Jacket | 73-75 | 73-75 | 70-73 | 73-74 | 76-77 |
| Temp, F. | | | | | |
| Turb Jacket | 74 | 74 | 72 | 74 | 76 |
| Temp, F. (est. | | | | | |
| representative | | | | | |
| value during | | | | | |
| run) | | | | | |
| Turb Product | 119-149 | 111-148 | 103-106 | 103-109 | 114-131 |
| Temp, F. | | | | | |
| Turb Prod | 148 | 142 | 104 | 106 | 125 |
| Temp, F. (est. | | | | | |
| representative | | | | | |
| value | | | | | |
| during run) | | | | | |

The resulting mixtures were extruded through an Extrud-O-Mix (EM-6-K5F424) extruder with 0.9 mm holes in the die plate at 41-125° C. (106-257° F.). The extrusion conditions are shown in Table 3.

TABLE 3

| | Blend # | | | | |
|---|---|---|---|---|---|
| | A | | | | |
| | Control | B | C | D | E |
| Extrud-O-Mix | | | | | |
| (EM-6-K5F424) | | | | | |
| Speed, rpm | 60 | 60 | 75 | 120 | 70 |
| Feed Load, ave | 3.8-4.2 | 3.5-4.6 | 7.5-8.4 | 8.5-9.2 | 5.2-5.2 |
| kW | | | | | |
| Feed load ave kW | 4.0 | 3.6 | 8.2 | 8.6 | 5.2 |
| rep value | | | | | |
| No Load, kW | 0.8 | 0.8 | 0.8 | 0.8 | 0.8 |
| Jacket Temp, F. | 66-67 | 66-66 | 66-67 | 73-75 | 72-72 |
| Jacket temp F. rep | 67 | 66 | 66 | 74 | 72 |
| value | | | | | |
| Product Temp, F. | 146-186 | 127-193 | 290-254 | 103-109 | 225-270 |
| Product Temp, F. | 186 | 185 | 257 | 106 | 240 |
| (est. representative | | | | | |
| value during run) | | | | | |

After extrusion, the extrudate is sent directly to a tumbler drum cooler. The drum cooler was a stainless steel drum approximately 3 feet in diameter and 8 feet in length. The tumbler was cooled by flowing nitrogen (evaporated gas from a liquid nitrogen cylinder) through the tumbler. The tumbler had open ends approximately 2 feet in diameter. A plastic sheet was placed over the end of the tumbler to maintain a low percentage of oxygen in the cooler. It was not sealed during the production runs.

Cooling data is shown in Table 4. The nitrogen temperatures were measure periodically using a probe held at the entrance and exit of the tumbler. The inlet solids temperature was measured periodically using a hand held probe in the flow of material exiting the extruder. The solids-out temperature was measured periodically using a hand held probe in the material at the exit of the tumbler. Product was removed periodically with a shovel and stored in drums.

TABLE 4

| | Blend # | | | | |
|---|---|---|---|---|---|
| | A | B | C | D | E |
| Tumbler (drum | | | | | |
| cooler) | | | | | |
| Solids Out Temp, F. | 50-89 | 75-84 | 80-91 | 83-97 | 91-101 |
| Solids Out Temp, F. | 89 | 80 | 82 | 91 | 97 |
| (est. representative | | | | | |
| value during run) | | | | | |
| Gas Temp, F. | 90-75 | 74-81 | 74-82 | 78-82 | 82-86 |
| Gas Temp, F. (est. | 77 | 77 | 80 | 80 | 84 |
| representative value | | | | | |
| during run) | | | | | |
| Blower N₂ In, F | 45-29 | 40-28 | 21-63 | 26-26 | 15-73 |
| Blower N₂ In (est. | 29 | 33 | 30 | 26 | 30 |
| representative value | | | | | |
| during run) | | | | | |
| Blower N₂ Out, F | 111-74 | 88-77 | 65-88 | 71-76 | 112-69 |
| Blower N₂ Out (est. | 74 | 79 | 85 | 72 | 80 |
| representative value | | | | | |
| during run) | | | | | |
| Loose Bulk Density | 27.8 | 23.7 | 33.1 | 34.4 | 28.1 |
| | 31.3 | 24.8 | 35.3 | 35.8 | 30.7 |
| | | 27.5 | 37.6 | 35.9 | 30.7 |
| | | 29.9 | 37.0 | 36.4 | 31.2 |
| | | | | | 31.4 |
| | | | | | 31.5 |
| Ave Bulk Den lb/ft³ | 29.6 | 26.5 | 35.8 | 35.6 | 30.6 |

Upon removal from the Tumbler, the product, including the control, was compared to industry specifications. The results of this testing are shown in Table 5.

TABLE 5

| | | Blend # | | | | |
|---|---|---|---|---|---|---|
| Analytical Data | Spec | A | B | C | D | E |
| Assay, % | 78-83 | 78.9 | 76.8 | 81.6 | 82.5 | 82.0 |
| PM 11582 (SLABS), % | 1.8-3.6 | 2.9 | 3.2 | 2.1 | 0.2 | 0.1 |
| Bulk Density, GLI | 600-700 | 647.0 | * | 625.0 | 663.0 | 659.0 |
| Cake Grade, LB | <2 | 0.0 | 0.0 | 0.8 | 0.2 | 0.2 |
| Hunter Color, L | ? | 86.6 | 85.6 | 86.2 | 87.8 | 87.0 |
| value | | | | | | |
| Hunter Color, A | >−1 | −0.2 | −0.6 | 0.0 | −0.1 | 0.2 |
| value | | | | | | |
| Hunter Color, B | | 7.4 | 7.5 | 7.7 | 6.4 | 6.9 |
| value | | | | | | |
| Hunter Color, E | <10 | 8.8 | 6.3 | 6.0 | 4.0 | 4.9 |
| value | | | | | | |
| Iron, ppm | <50 | 6.5 | 5.6 | 4.0 | 2.5 | 6.2 |
| Partical Size Thru 14 | 95-105 | 75.4 | 84.0 | 81.0 | 85.8 | 87.0 |
| on 35 | | | | | | |
| Partical Size Thru 35 | <2.8 | 0.4 | 0.4 | 0.2 | 6.8 | 0.2 |
| mesh | | | | | | |
| Friability, % | <6 | 2.2 | 2.2 | 5.2 | 6.0 | 3.0 |
| Solubility % | <44 | 32.0 | 40.3 | 2.0 | 37.9 | 38.6 |

All of the resulting granules were then tested against a leading commercial detergent with regard to stain removal ability using standardized testing procedures. UL conducted the standardized testing. All granules exhibited commercially acceptable results as when compared to the commercial detergent.

Pellets that contained nonanoic acid had a noticeably stronger odor when dissolved in water. Pellets that contained C16 fatty acid remain hazy when dissolved in water but higher extrusion temperatures were observed when C16 fatty acid was absent from the binder mixture.

As shown by Blend C, it was discovered that glycerin is capable of completely replacing fatty acids in a binder composition and still obtain a commercially acceptable bleach activator product. Blends B and D show that acceptable detergent performance can be maintained in the absence of nonanoic acid by combining glycerin with low levels of C16 fatty acid.

In some respects using glycerin to replace fatty acids results in improved product because glycerin is non-toxic, stable at extrusion temperatures, and provides lubricity in the extrusion process. Perhaps more importantly, glycerin provides a bleach activator product with less odor when pellets are dissolved in water and improved solubility as compared to products that contain nonanoic acid and C16 fatty acid. In the absence of C16 fatty acid in the binder mixture, the pellets completely dissolve in water to provide a clear solution.

The preceding detailed description is to be considered in all respects only as illustrative and not restrictive, and the scope of the invention is, therefore, indicated by the appended claims rather than the foregoing description. Those of skill in the art will recognize changes, substitutions and other modifications that will nonetheless come within the scope of the invention and range of the

That which is claimed is:

1. A process for the preparation of bleach activator granules, the process comprising the step of extruding a mixture comprising a bleach activator and a binder, said binder comprising an anionic or nonionic surfactant, a polyglycol and glycerin.

2. A process according to claim 1 wherein said binder does not contain a fatty acid.

3. A process according to claim 1 wherein said binder further comprises afatty acid.

4. A process according to claim 1 wherein said bleach activator is selected from the group consisting of TAED, NOBS, iso-NOBS, DOBA, LOBS, DOBS, GOBS, and NOBA.

5. A process according to claim 3 wherein said bleach activator is selected from the group consisting of TAED, NOBS, iso-NOBS, DOBA, LOBS, DOBS, GOBS, and NOBA.

6. A process according to claim 1 wherein the total mixture comprises, by weight, 50%-95% bleach activator, 0.1%-18% anionic or nonionic surfactant, 1.0% to 23% polyglycol, and 0.5%-19.0% glycerin.

7. A process according to claim 3 wherein the total mixture comprises, by weight, 50%-95% bleach activator, 0.1%-18% anionic or nonionic surfactant, 1.0% to 23% polyglycol, 0.5%-19.0% glycerin and 0.01%-8.0% fatty acid.

8. A laundry detergent composition comprising:
a bleach activator, and
a binder, said binder comprising an anionic or nonionic surfactant, a polygycol and glycerin.

9. A laundry detergent composition according to claim 8 wherein said binder does not contain a fatty acid.

10. A laundry detergent composition according to claim 8 wherein said binder further comprises a fatty acid.

11. A laundry detergent composition according to claim 8 wherein said bleach activator is selected from the group consisting of TAED, NOBS, iso-NOBS, DOBA, LOBS, DOBS, GOBS and NOBA.

12. A laundry detergent composition according to claim 10 wherein said bleach activator is selected from the group consisting of TAED, NOBS, iso-NOBS, DOBA, LOBS, DOBS, OOBS, and NOBA.

13. A laundry detergent composition according to claim 8 wherein the composition comprises, by weight, 50%-95% bleach activator, 0.1%-18% anionic or nonionic surfactant, 1.0% to 23% polyglycol, and 0.5%-19.0% glycerin.

14. A laundry detergent composition according to claim 10 wherein the composition comprises, by weight, 50%-95% bleach activator, 0.1%-18% anionic or nonionic surfactant, 1.0% to 23% polyglycol, 0.5%-19.0% glycerin and 0.01%-8.0% fatty acid.
